(19) United States
(12) Patent Application Publication
(10) Pub. No.: US 2023/0391038 A1
(43) Pub. Date: Dec. 7, 2023

(54) BOX-MAKING DEVICE

(71) Applicant: KYOTO SEISAKUSHO CO., LTD., Kyoto-shi, Kyoto (JP)

(72) Inventor: Motoyuki KITAMURA, Kyoto-shi, Kyoto (JP)

(21) Appl. No.: 18/022,575

(22) PCT Filed: May 28, 2021
(86) PCT No.: PCT/JP2021/020409

§ 371 Date: Feb. 22, 2023

(30) Foreign Application Priority Data
Oct. 5, 2020 (JP) 2020-168687

(51) Int. Cl. B31B 50/26; B31B 50/62

(52) U.S. Cl. CPC B31B 50/26; B31B 50/62

(57) ABSTRACT

Provided is a box-making device capable of making a carton comprising a body portion, outer flaps, and middle flaps. The box-making device comprises: a conveyance device having a conveyor for conveying the carton and upstream-side spacers; applicators for applying a bonding material to the middle flaps; flap-folding guides for folding the outer flaps at the outer side of the middle flaps; pushing rollers for pushing the outer flaps toward the middle flaps; and regulating members for regulating the posture of the outer flaps in the conveyance direction by coming into contact with the upstream-side end parts of the outer flaps at least at the point when the outer flaps begin to come into contact with the bonding material.

### TECHNICAL FIELD

The present invention relates to a box-making device for cartons.

### BACKGROUND ART

Conventionally, there is a known box-making device for making a box by filling a carton expanded into a tubular shape with a to-be-enclosed object, and subsequently folding flaps of the carton while conveying the carton by a conveyor.

In such a box-making device, as disclosed in Patent Literature 1 for example, a carton is made by folding lower flaps of a tubular carton upwardly while being transported, then applying a bonding material to the folded lower flaps, and further folding upper flaps to bond the upper and lower flaps together.

In this case, each upper flap is folded by being pushed down by a folding guide having an inclined side that is inclined downwardly toward the downstream side in the transportation direction. However, while the carton is being made, the carton may collapse toward the upstream side in the transportation direction due to a force of pushing down the upper flap by the folding guide.

Accordingly, in the box-making device disclosed in Patent Literature 1, the carton is prevented from collapsing toward the upstream side in the transportation direction by putting, from the upstream side in the transportation direction, a redressment body to an upper end part of the carton being transported.

### CITATIONS LIST

### PATENT LITERATURE

Patent Literature 1: JP-B-5232036 Gazette

### SUMMARY OF INVENTION

### Technical Problems

However, since the redressment body in the box-making device of Patent Literature 1 is configured to come into contact with a body portion of the carton, even if it is possible to prevent the body portion of the carton from collapsing, there is a possibility that the upper flap is deformed due to the pushing-down force from the folding guide and a box is made in a state where the position of the upper flap is displaced with respect to the body portion.

Therefore, the present invention provides a box-making device capable of preventing a carton from being made in a state where the positional displacement of a flap occurs.

### Solutions to Problems

The problem to be solved by the present invention is as described above, and a means for solving the problem will be described below.

Specifically, such a box-making device is a box-making device for making a carton including a body portion formed in a tubular shape, first flaps formed at axial ends of the body portion, and second flaps facing the first flaps by bonding the first flaps and the second flaps together in a folded state, the box-making device comprising: a transporter including a transportation conveyor for transporting the carton and spacers that are provided on the transportation conveyor and are capable of supporting upstream-side end parts of the carton being transported; applicators for applying a bonding material to the second flaps in a folded state; flap-folding guides for folding the first flaps at the outer sides of the second flaps in a folded state by coming into contact with the first flaps in accordance with the transportation of the carton; pushing members for pushing the first flaps folded by the flap-folding guides toward the second flaps so as to bring the first flaps and the bonding material applied to the second flaps into contact with each other; and regulating members for regulating orientations of the first flaps in a transportation direction at least when the contact between the first flaps pushed by the pushing members and the bonding material begins, by coming into contact with at least upstream-side end parts of the first flaps in the carton.

Accordingly, the first flap can be bonded to the second flap in an orientation in which no positional displacement occurs, and it is possible to prevent the carton from being made in a state where the positional displacement occurs in the first flap.

The regulating member comes into contact with only the upstream-side end part of the first flap in the carton when regulating the orientation of the first flap.

Accordingly, it is possible to regulate the orientation of the outer flap in the transportation direction in accordance with the shape of the outer flap.

The regulators including endless belts to be rotationally driven and the regulating members attached to outer peripheral surfaces of the endless belts, the regulating members moving in accordance with the rotations of the endless belts, are provided, and the regulator includes a contactable region where the regulating member moves along the transportation direction of the carton and the moving regulating member is contactable with the first flap, and a retraction region where the regulating member moves at a position farther away from the carton as compared with when the regulating member moves in the contactable region, and the regulating member that comes into contact with the first flap in the contactable region is separated from the first flap before moving from the contactable region to the retraction region.

Accordingly, it is possible to prevent the first flap from being deformed by the regulating member moving from the contactable region to the retraction region resulting in the bending tendency left on the first flap.

The regulating member that is separated from the first flap in the retraction region comes into contact with the first flap after moving from the retraction region to the contactable region.

Accordingly, the orientation of the first flap can be stably regulated.

### Advantageous Effects of Invention

According to the present invention, it is possible to prevent the carton from being made in a state where positional displacement occurs in a flap.

### BRIEF DESCRIPTION OF DRAWINGS

FIG. 1 is a plan view showing a box-making device.

FIG. 2 is a side view showing the box-making device.

FIG. 3 is a cross-sectional view illustrating the box-making device as viewed from the upstream side in a carton transportation direction.

FIG. 4 is a perspective view illustrating a carton.

FIG. 5 is a block diagram showing an electrical configuration of the box-making device.

FIG. 6 is a side view illustrating a state in which a regulating member is in contact with an outer flap of a carton transported by a transportation conveyor.

FIG. 7 is a cross-sectional view illustrating a state in which the regulating member is in contact with the outer flap of a carton transported by the transportation conveyor as viewed from the upstream side in the carton transportation direction.

FIGS. 8A and FIG. 8B are plan views illustrating an operation of the regulating member: FIG. 8A is a view illustrating a state in which the regulating member moves on a downstream-side end part in a moving direction in a retraction region, and FIG. 8B is a view illustrating a state in which the regulating member comes into contact with an upstream-side end part of the outer flap after shifting from the retraction region to the contactable region.

FIGS. 9A and FIG. 9B are a plan view illustrating an operation of the regulating member: FIG. 9A is a view illustrating a state in which the regulating member moving in the contactable region is separated from the outer flap, and FIG. 9B is a view illustrating a state in which the regulating member has shifted from the contactable region to the retraction region.

FIG. 10A is a side view illustrating a state in which the regulating member is in contact with a cylindrical body and the outer flap of a carton transported by the transportation conveyor, and FIG. 10B is a cross-sectional view of a state in which the regulating member is in contact with the cylindrical body and the outer flap of the carton transported by the transportation conveyor as viewed from the upstream side in the carton transportation direction.

FIG. 11 is a side view illustrating a modification of the regulator.

### DESCRIPTION OF EMBODIMENT

Next, modes for carrying out the present invention will be described with reference to the accompanying drawings.

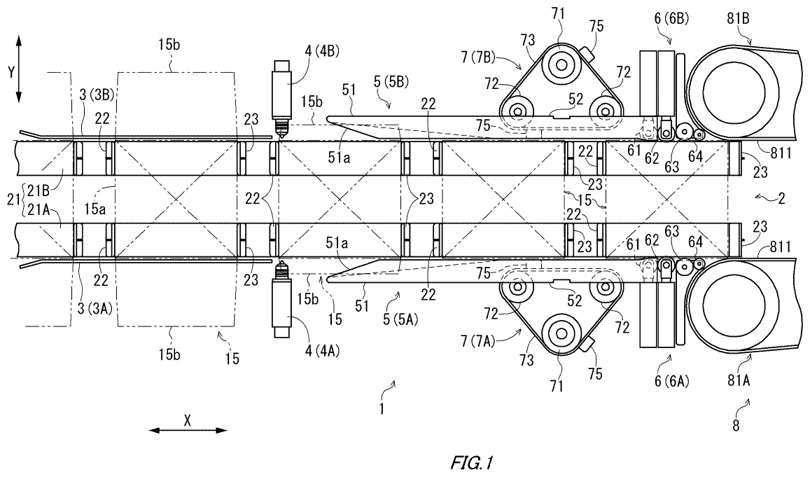

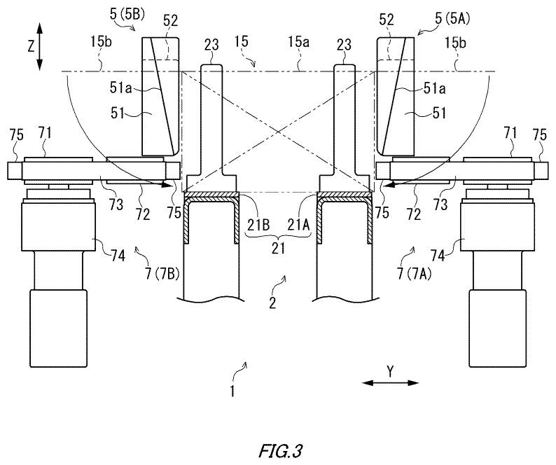

A box-making device 1 illustrated in FIGS. 1 to FIG. 3 is a box-making device for making a box by filling a carton 15 expanded in a tubular shape with a to-be-enclosed object and then folding flaps of the carton 15 while transporting the carton 15 by a conveyor. The box-making device 1 includes a first transporter 2, a pushing plate 3, a coating applicator 4, a flap-folding guide 5, a pushing roller 6, a regulator 7, and a second transporter 8.

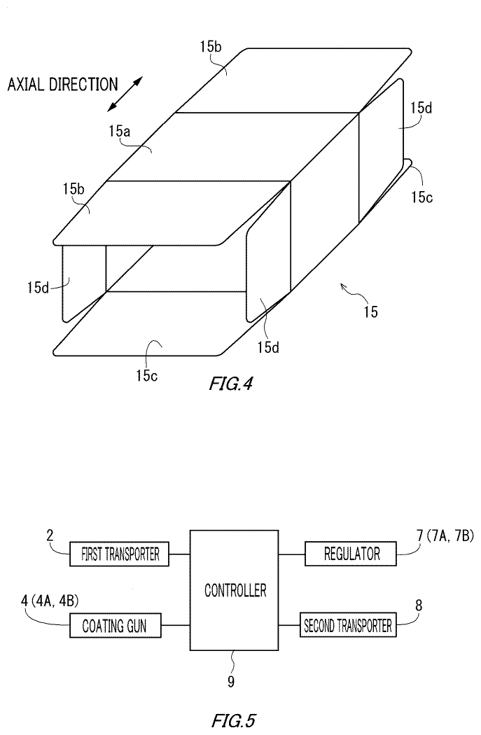

As illustrated in FIG. 4, the carton 15 made by the box-making device 1 includes a body portion 15a to be formed in a tubular shape, and outer flaps 15b, middle flaps 15c, and inner flaps 15d formed at both axial ends of the body portion 15a.

The outer flap 15b and the middle flap 15c are provided on two opposing sides at each axial end of the body portion 15a. A pair of the inner flaps 15d are provided on two sides, at each axial end of the body portion 15a, different from the two sides on which the outer flap 15b and the middle flap 15c are provided. The outer flap 15b is an example of a first flap formed at each axial end of the body portion. The middle flap 15c is an example of a second flap facing the first flap.

The carton 15 is expanded such that the body portion 15a is unfolded into a tubular shape from a flatly-folded state, and after the body portion 15a is filled with a to-be-enclosed object from one axial side, the inner flaps 15d, the middle flaps 15c, and the outer flaps 15b are folded in this order, and then, the middle flaps 15c and the outer flaps 15b are bonded in a folded state, thereby making a box.

As illustrated in FIG. 5, the box-making device 1 includes a controller 9 to which the first transporter 2, the coating applicator 4, the regulator 7, and the second transporter 8 are connected. The controller 9 is capable of controlling the operations of the first transporter 2, the coating applicator 4, the regulator 7, and the second transporter 8. The controller 9 is, for example, a central processing unit (CPU) configured by a microprocessor or the like.

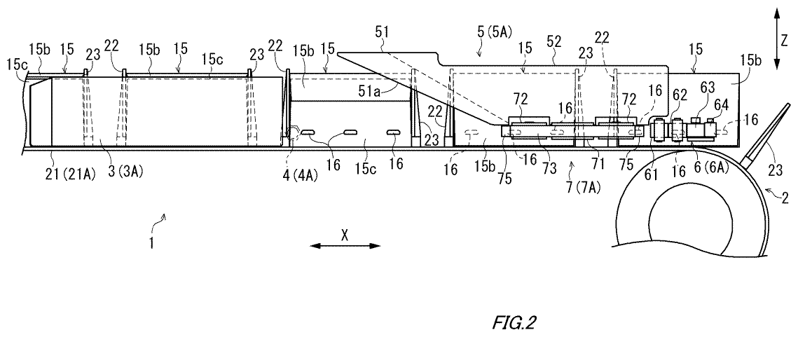

In the present embodiment, the left-right direction in FIGS. 1 and 2 is defined as an X direction. Besides, a direction orthogonal to the X direction in the horizontal direction is defined as a Y direction. Furthermore, a direction orthogonal to the X direction and the Y direction is defined as a Z direction.

As illustrated in FIGS. 1 to FIG. 3, the first transporter 2 includes a transportation conveyor 21 that conveys the carton 15, and an upstream-side spacer 22 and a downstream-side spacer 23 provided on the transportation conveyor 21. The transportation conveyor 21 is configured by a belt conveyor extending along the X direction and conveys the placed carton 15 along the X direction. In the present embodiment, the transportation conveyor 21 conveys the carton 15 from the left side to the right side in FIGS. 1 and FIG. 2. In the transportation conveyor 21, the transportation, the stop, the transportation speed, and the like of the carton 15 are controlled by the controller 9.

The carton 15 transported by the transportation conveyor 21 is placed on the transportation conveyor 21 such that the axial direction of the cylindrical body portion 15a is in an orientation along the Y direction. Furthermore, the carton 15 is placed on the transportation conveyor 21 in such an orientation that the outer flap 15b is positioned on the upper side, the middle flap 15c is positioned on the lower side, and the inner flaps 15d are positioned on both sides in the X direction, at each axial end of the body portion 15a.

The body portion 15a of the carton 15 placed on the transportation conveyor 21 is filled with a to-be-enclosed object from one side in the Y direction. In FIG. 1, in the Y direction, the lower side of the transportation conveyor 21 is a filling side on which the body portion 15a is filled with the to-be-enclosed object, and the upper side of the transportation conveyor 21 is a filling-side opposite side opposed to the filling side.

The transportation conveyor 21 includes a filling-side conveyor 21A and a filling-side-opposite-side conveyor 21B. The filling-side conveyor 21A and the filling-side-opposite-side conveyor 21B are disposed with a gap therebetween in the Y direction, and the filling-side conveyor 21A is located closer to the filling side as compared with the filling-side-opposite-side conveyor 21B.

The upstream-side spacer 22 and the downstream-side spacer 23 are plate-shaped members protruding from the transportation conveyor 21 and are provided on each of the filling-side conveyor 21A and the filling-side-opposite-side conveyor 21B. The upstream-side spacers 22 and the downstream-side spacers 23 are disposed with a gap corresponding to the size of the carton 15 in the transportation direction of the carton 15. The upstream-side spacers 22 are positioned so as to be adjacent to upstream-side end parts of the carton 15 placed on the transportation conveyor 21, and the downstream-side spacers 23 are positioned so as to be adjacent to downstream-side end parts of the carton 15 placed on the transportation conveyor 21.

The upstream-side spacers 22 and the downstream-side spacers 23 regulate the position of the carton 15 placed on the transportation conveyor 21 in the transportation direction with respect to the transportation conveyor 21, and the carton 15 is placed between the upstream-side spacers 22 and the downstream-side spacers 23, whereby the cartons 15 are placed on the transportation conveyor 21 at equal intervals.

Furthermore, the upstream-side spacers 22 can support the upstream-side end parts of the carton 15 by coming into contact with the upstream-side end parts, and the downstream-side spacers 23 can support the downstream-side end parts of the carton 15 by coming into contact with the downstream-side end parts. Each upstream-side spacer 22 is an example of a spacer capable of supporting the upstream-side end part of the carton being transported.

The pushing plate 3 is formed of a plate-shaped member and is provided on each lateral part of the transportation conveyor 21 in the Y direction. Each pushing plate 3 is provided in such a standing orientation that a plate surface thereof extends along the transportation direction of the carton 15 on the lateral part of the transportation conveyor 21.

In the carton 15 transported by the transportation conveyor 21, on the upstream side with respect to the position where the pushing plates 3 are provided, the body portion 15a is filled with a to-be-enclosed object, and the inner flaps 15d and the middle flaps 15c are in a folded state. In this case, the inner flaps 15d are folded before the middle flaps 15c, and the middle flaps 15c are positioned on the outer sides in the Y direction as compared with the inner flaps 15d. The outer flaps 15b are not folded yet but extend outward in the Y direction from the body portion 15a.

When the carton 15 with the inner flaps 15d and the middle flaps 15c being in a folded state reaches a position where the pushing plates 3 are provided, the middle flaps 15c come into contact with the pushing plates 3 so as to be prevented from expanding outwardly in the Y direction. As a result, the carton 15 is transported while retaining a state where the inner flaps 15d and the middle flaps 15c are folded.

The box-making device 1 includes, as the pushing plate 3, a pushing plate 3A disposed on a lateral part on the filling side of the transportation conveyor 21 in the Y direction, and a pushing plate 3B disposed on a lateral part on the filling-side opposite side of the transportation conveyor 21. The pushing plate 3A and the pushing plate 3B are formed into shapes symmetrical to each other with a straight line extending along the X direction interposed therebetween. The pushing plate 3A retains a state in which the inner flaps 15d and the middle flap 15c on the filling side are folded, and the pushing plate 3B retains a state in which the inner flaps 15d and the middle flap 15c on the filling-side opposite side are folded.

The coating applicator 4 is disposed on the downstream side of each pushing plate 3 in the transportation direction of the carton 15. The coating applicators 4 are provided on lateral parts of the transportation conveyor 21 in the Y direction. Each coating applicator 4 applies a bonding material 16 to the middle flap 15c, in a folded state, of the carton 15 while being transported. The bonding material 16 is applied to, for example, a lower portion of the middle flap 15c in a folded state. The coating applicator 4 is an example of an applicator for applying a bonding material. In the coating applicator 4, the controller 9 controls the application position and the application amount of the bonding material 16 on the middle flap 15c.

The box-making device 1 includes, as the coating applicator 4, a coating applicator 4A disposed on a lateral part on the filling side of the transportation conveyor 21 in the Y direction, and a coating applicator 4B disposed on a lateral part on the filling-side opposite side of the transportation conveyor 21. The coating applicator 4A and the coating applicator 4B are configured to be symmetrical with a straight line extending along the X direction interposed therebetween. The coating applicator 4A applies the bonding material 16 to the middle flap 15c on the filling side, and the coating applicator 4B applies the bonding material 16 to the middle flap 15c on the filling-side opposite side.

The flap-folding guide 5 is disposed on the downstream side of each coating applicator 4 in the transportation direction of the carton 15. The flap-folding guide 5 is formed of a plate-shaped member and is provided on each lateral part of the transportation conveyor 21 in the Y direction. Each flap-folding guide 5 is provided in such a standing orientation that a plate surface thereof extends along the transportation direction of the carton 15 on the lateral part of the transportation conveyor 21. Each flap-folding guide 5 includes a folding portion 51 having an inclined side 51a inclined downwardly toward the downstream side in the transportation direction, and a retaining portion 52 formed so as to be contiguous to the downstream side of the folding portion 51.

When the carton 15 being transported reaches the position of the flap-folding guides 5, the outer flaps 15b extending in the Y direction come into contact with the folding portions 51 of the flap-folding guides 5 and are folded downwardly while the carton 15 is transported.

In this case, as the carton 15 moves to the downstream side in the transportation direction, the outer flaps 15b are sequentially pushed down at the downstream-side end parts toward the upstream side by the inclined sides 51a of the folding portions 51. The pushed-down outer flaps 15b are folded at the outer sides of the middle flaps 15c which are in a folded state. After being folded downwardly by the folding portions 51, the outer flaps 15b are retained in a folded state while being in contact with the retaining portions 52.

The box-making device 1 includes, as the flap-folding guide 5, a flap-folding guide 5A disposed on a lateral part on the filling side of the transportation conveyor 21 in the Y direction, and a flap-folding guide 5B disposed on a lateral part on the filling-side opposite side of the transportation conveyor 21. The flap-folding guide 5A and the flap-folding guide 5B are configured into shapes symmetrical to each other with a straight line extending along the X direction interposed therebetween. The flap-folding guide 5A folds the outer flap 15b on the filling side downwardly, and the flap-folding guide 5B folds the outer flap 15b on the filling-side opposite side downwardly.

The pushing roller 6 is disposed on the downstream side of each flap-folding guide 5 in the transportation direction of the carton 15. The pushing rollers 6 are provided on lateral parts of the transportation conveyor 21 in the Y direction. Each pushing roller 6 is formed as a pushing member that brings the bonding material 16 applied to the middle flap 15c into contact with the outer flap 15b by pushing the outer flap 15b folded by the flap-folding guide 5 toward the middle flap 15c.

Each pushing roller 6 is disposed at the same height position as the position of the bonding material 16 applied to the middle flap 15c in the vertical direction, and a part, of the outer flap 15b, pushed by the pushing roller 6 comes into contact with the bonding material 16 applied to the middle flap 15c, thereby bonding the outer flap 15b and the middle flap 15c together. As described above, the outer flap 15b and the middle flap 15c are bonded together in a folded state by the pushing roller 6, whereby the carton 15 is made.

Each pushing roller 6 includes a first roller 61 positioned on the most upstream side, a second roller 62 positioned on the downstream side of the first roller 61, a third roller 63 positioned on the downstream side of the second roller 62, and a fourth roller 64 positioned on the downstream side of the third roller 63.

As the carton 15 moves to the downstream side in the transportation direction, each outer flap 15b is sequentially pushed by the first roller 61, the second roller 62, the third roller 63, and the fourth roller 64, and bonded to the middle flap 15c. Note that the first roller 61, the second roller 62, the third roller 63, and the fourth roller 64 are driven rollers driven to rotate by coming into contact with the outer flap 15b of the carton 15 being transported.

The box-making device 1 includes, as the pushing roller 6, a pushing roller 6A disposed on a lateral part on the filling side of the transportation conveyor 21 in the Y direction, and a pushing roller 6B disposed on a lateral part on the filling-side opposite side of the transportation conveyor 21. The pushing roller 6A pushes the outer flap 15b on the filling side toward the middle flap 15c, and the pushing roller 6B pushes the outer flap 15b on the filling-side opposite side toward the middle flap 15c.

As described above, in a case where the outer flaps 15b are folded downwardly and bonded to the middle flaps 15c, if the carton 15 is transported to the downstream side in a state where the outer flaps 15b are pushed down by the inclined sides 51a of the folding portions 51 or the folded outer flaps 15b are in contact with the retaining portions 52, a pushing force is applied to the outer flaps 15b in a direction toward the upstream side in the transportation direction.

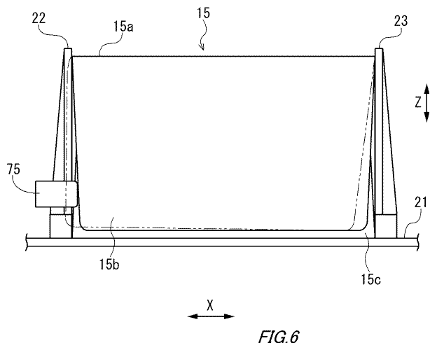

When a pushing force in a direction toward the upstream side is applied to the outer flaps the body portion 15a tends to collapse toward the upstream side in the transportation direction. However, since the upstream-side end parts of the body portions 15a come into contact with and are supported by the upstream-side spacers 22, the body portion is prevented from collapsing toward the upstream side in the transportation direction. On the other hand, as indicated by a two-dot chain line in FIG. 6, the outer flap 15b may be deformed toward the upstream side in the transportation direction by the pushing force from the folding portion 51 or the retaining portion 52 and may be displaced with respect to the body portion 15a.

When the outer flap 15b is bonded to the middle flap 15c in a state where the outer flap is displaced with respect to the body portion 15a, the bonding state may be affected, or the appearance of the carton 15 after being made may be deteriorated. In particular, if the bonded outer flap 15b protrudes from the body portion 15a, the appearance of the carton 15 may be greatly impaired.

Therefore, in the box-making device 1, the orientation of each outer flap 15b in the transportation direction is regulated by the regulator 7 to suppress the occurrence of the positional displacement of the outer flap 15b. As shown in FIGS. 1 to FIG. 3, the regulator 7 is disposed below each retaining portion 52 in the flap-folding guide 5. The regulators 7 are provided on lateral parts of the transportation conveyor 21 in the Y direction.

Each regulator 7 includes a driving pulley 71 disposed on a lateral part of the transportation conveyor 21, and a driven pulley 72 disposed closer to the transportation conveyor 21 as compared with the driving pulley 71 on the lateral part of the transportation conveyor 21, a belt 73 which is an endless belt wound around the driving pulley 71 and the driven pulley 72, a motor 74 which is a driving source for driving the driving pulley 71, and a regulating member 75 attached to an outer peripheral surface of the belt 73.

In the present embodiment, the regulator 7 includes two driven pulleys 72, and the two driven pulleys 72 are arranged side by side along the transportation direction of the carton 15. A portion, of the belt 73, positioned between the driven pulley 72 and the driven pulley 72 extends along the transportation direction of the carton 15. That is, an extending direction of the portion, of the belt 73, positioned between the driven pulley 72 and the driven pulley 72 is parallel to the X direction.

The controller 9 is capable of controlling the operation of the motor 74, and the driving pulley 71 is driven by the controller 9 controlling the operation of the motor 74. When the driving pulley 71 is driven, the belt 73 rotates, and the regulating member 75 moves along a rotation direction of the belt 73 in accordance with the rotation of the belt 73. The moving speed of the regulating member 75 is adjustable through the control of the controller 9. The regulating member 75 is formed of a rectangular block-shaped member in which a dimension in the moving direction is longer than a dimension in the thickness direction in a plan view.

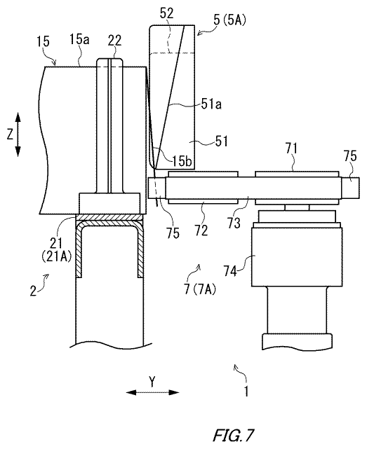

In the regulator 7 configured as described above, the regulating member 75 is moved in accordance with the transportation operation of the carton 15 and the regulating member 75 is brought into contact with an upstream-side end part of the outer flap 15b, thereby regulating the orientation of the outer flap 15b in the transportation direction, as shown in FIGS. 6 and FIG. 7.

Specifically, the regulating member 75 is moved toward the downstream side at the same speed as the transportation speed of the carton 15 transported by the transportation conveyor 21 in a state where the regulating member 75 is brought into contact with the upstream-side end part of the outer flap 15b retained in a folded state by the retaining portion 52 of the flap-folding guide 5.

In this case, the regulating member 75 in contact with the outer flap 15b is moved such that the position of the upstream-side end part of the outer flap 15b with no positional displacement and the position of the downstream-side end part of the regulating member 75 are aligned relative to each other in the X direction. As a result, it is possible to regulate the orientation of the outer flap 15b in the transportation direction to a posture with no displacement. In a case where the outer flap 15b is about to deform from a position where no positional displacement occurs toward an upstream side, as the upstream-side end part of the outer flap 15b is in contact with the regulating member 75, the deformation of the outer flap 15b toward the upstream side is suppressed.

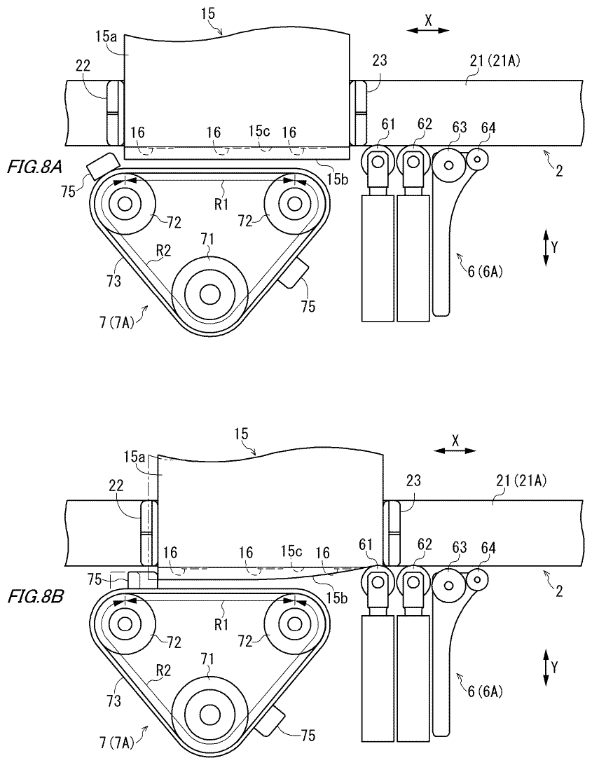

As illustrated in FIG. 8, the regulator 7 includes a contactable region R1 where the regulating member 75 moves along the transportation direction of the carton 15 and the regulating member 75 which is moving is contactable with the outer flap 15b, and a retraction region R2 where the regulating member 75 moves at a position farther away from the carton 15 as compared with a case where the regulating member 75 moves in the contactable region R1.

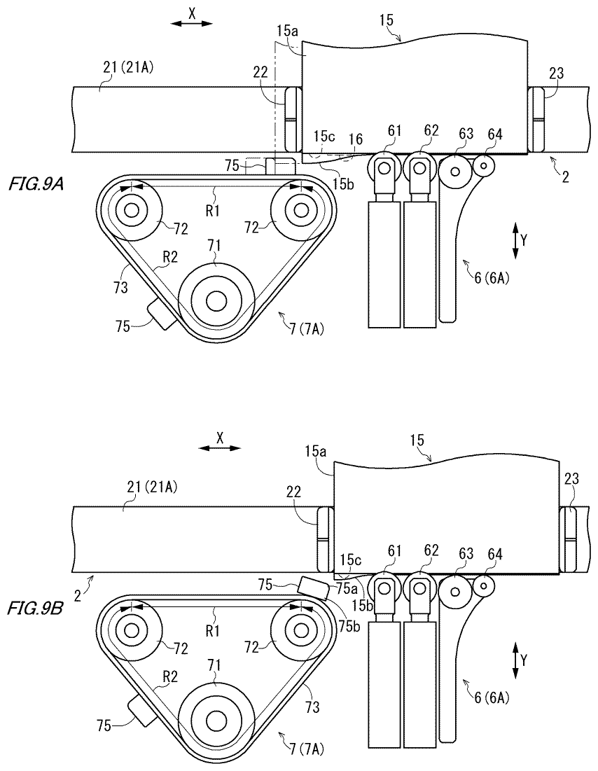

When moving in the contactable region R1, the regulating member 75 moves toward the downstream side in parallel with the transportation direction of the carton 15 and is contactable with the upstream-side end part of the outer flap 15b. Furthermore, after the regulating member 75 has shifted from the contactable region R1 to the retraction region R2, and when the regulating member 75 moves in a portion where the belt 73 is wound around the driven pulley 72 on the downstream side, that is, on the upstream-side end part in the moving direction of the retraction region R2, the regulating member 75 moves in a direction inclined with respect to the transportation direction of the carton 15 (see FIG. 9B). Furthermore, before the regulating member 75 shifts to the contactable region R1 from the retraction region R2, and when the regulating member 75 moves in a portion where the belt 73 is wound around the driven pulley 72 on the upstream side, that is, on the downstream-side end part in the moving direction of the retraction region R2, the regulating member 75 moves in a direction inclined with respect to the transportation direction of the carton 15 (see FIG. 8A).

The regulating member 75 operates as follows in order to regulate the orientation of the outer flap 15b in the transportation direction. First, as illustrated in FIG. 8A, when the regulating member 75 which is moving in the retraction region R2 reaches the downstream-side end part of the retraction region R2, there is a gap between the regulating member 75 and the outer flap 15b in the X direction. The moving speed of the regulating member 75 which is moving in the downstream-side end part of the retraction region R2 is the same as the transportation speed of the carton 15. In this state, the outer flap 15b is folded downwardly, but is not yet pushed by the pushing roller 6 and is not yet in contact with the bonding material 16. The moving direction of the regulating member 75 is inclined with respect to the X direction.

When the regulating member 75 moves from the state illustrated in FIG. 8A and shifts to the contactable region R1, the moving direction of the regulating member 75 becomes parallel to the X direction. First, as indicated by a two-dot chain line in FIG. 8B, when the regulating member 75 reaches a boundary between the retraction region R2 and the contactable region R1, there is a gap between the regulating member 75 and the outer flap 15b in the X direction.

The movement speed of the regulating member 75 becomes higher than the transportation speed of the carton 15 after the regulating member 75 has shifted to the contactable region R1, and the interval between the regulating member 75 and the outer flap 15b is reduced. Furthermore, the regulating member 75 comes into contact with the upstream-side end part of the outer flap 15b as indicated by a solid line in FIG. 8B.

When the relative position of the regulating member 75 in contact with the outer flap 15b with respect to the outer flap 15b reaches a position where the outer flap 15b is not displaced, the moving speed of the regulating member 75 becomes the same speed as the transportation speed of the carton 15, whereby a state where the regulating member 75 and the upstream-side end part of the outer flap 15b are in contact with each other is maintained.

As described above, the orientation of the outer flap 15b in the transportation direction is regulated by the regulating member 75 coming into contact with the upstream-side end part of the outer flap 15b, and the outer flap 15b is retained at a position where the outer flap 15b is not displaced with respect to the body portion 15a.

After the regulating member 75 comes into contact with the upstream-side end part of the outer flap 15b, the outer flap 15b is pushed by the pushing roller 6, whereby the contact between the outer flap 15b and the bonding material 16 begins. In this case, it is possible to achieve a configuration in which, once the regulating member 75 comes into contact with the upstream-side end part of the outer flap 15b and the outer flap 15b is retained at a position where the outer flap 15b is not displaced with respect to the body portion 15a, the outer flap 15b pushed by the pushing roller 6 comes into contact with the bonding material 16.

That is, the box-making device 1 is configured such that, at least when the contact between the outer flap 15b pushed by the pushing roller 6 and the bonding material 16 begins, the regulating member 75 comes into contact with the upstream-side end part of the outer flap in the carton 15, thereby regulating the orientation of the outer flap 15b in the transportation direction.

As described above, by regulating the orientation of the outer flap 15b by the regulating member 75, the outer flap 15b can be bonded to the middle flap 15c in an orientation where no positional displacement occurs, whereby it is possible to prevent the carton 15 from being made in a state where the positional displacement occurs in the outer flap 15b.

In a case where the orientation of the outer flap 15b is regulated by the regulating member 75, the regulating member 75 is separated from the outer flap 15b when moving in the retraction region R2 and comes into contact with the outer flap 15b after moving from the retraction region R2 to the contactable region R1. Therefore, the regulating member 75 is capable of coming into contact with the outer flap 15b in a state of moving parallel to the transportation direction of the carton 156, whereby the orientation of the outer flap 15b can be stably regulated. However, the regulating member 75 may be brought into contact with the outer flap 15b once the regulating member 75 reaches the boundary between the retraction region R2 and the contactable region R1.

In the box-making device 1, the timing of bringing the regulating member 75 into contact with the outer flap 15b in the contactable region R1 is adjusted in accordance with the size of the carton 15, and thus, the orientation of the outer flap 15b can be regulated by the regulating member 75 when the contact between the outer flap 15b and the bonding material 16 begins regardless of the size of the carton 15 being transported.

After the regulating member 75 comes into contact with the outer flap 15b, the carton 15 is transported while retaining a state where the orientation of the outer flap 15b is regulated by the regulating member 75, and the bonding between the outer flap 15b and the middle flap 15c by the bonding material 16 progresses from the downstream side to the upstream side of the outer flap 15b.

As indicated by a two-dot chain line in FIG. 9A, when the regulating member 75 moves in the contactable region R1 and reaches the downstream-side end part of the contactable region R1, the moving speed of the regulating member 75 becomes slower than the transportation speed of the carton 15. As a result, as indicated by a solid line in FIG. 9A, the regulating member 75 in contact with the outer flap 15b is separated from the outer flap 15b, whereby a gap is generated between the regulating member 75 and the outer flap 15b in the X direction. After a certain gap is generated between the regulating member 75 and the outer flap 15b, the moving speed of the regulating member 75 returns to the same speed as the transportation speed of the carton 15.

As illustrated in FIG. 9B, the regulating member 75 which is moving in the contactable region R1 shifts from the contactable region R1 to the retraction region R2 after a gap is formed between the regulating member 75 and the outer flap 15b. When the regulating member 75 shifts from the contactable region R1 to the retraction region R2, the regulating member 75 moves in a direction inclined with respect to the X direction, and a portion 75a, farther away from the belt 73, of the regulating member 75 at the downstream-side end part protrudes to the downstream side in the transportation direction of the carton 15 with respect to a portion 75b close to the belt 73.

However, the regulating member 75 is separated from the outer flap 15b before moving from the contactable region R1 to the retraction region R2 and there is a gap between the regulating member 75 and the outer flap 15b. Thus, the regulating member 75 which has shifted from the contactable region R1 to the retraction region R2 does not interfere with the outer flap 15b. Therefore, it is possible to prevent the outer flap 15b from being deformed by the regulating member 75 moving from the contactable region R1 to the retraction region R2 resulting in the bending tendency left on the outer flap 15b.

When the regulating member 75 is separated from the outer flap 15b at the downstream-side end part of the contactable region R1, the bonding between the outer flap 15b and the middle flap 15c is not completed, and the upstream-side end part of the outer flap 15b is not yet bonded to the middle flap 15c.

However, once the outer flap 15b and the middle flap 15c are bonded together at least at the downstream-side end part, the orientation of the outer flap 15b is no more shifted with respect to the body portion 15a. Therefore, even if the regulating member 75 is separated from the outer flap 15b before the bonding is completed, the outer flap 15b can maintain a state where no positional displacement occurs. The carton 15 is transported by the transportation conveyor 21 even after the regulating member 75 is separated from the outer flap 15b, and the bonding between the outer flap 15b and the middle flap 15c is completed.

As described above, when the outer flap 15b and the middle flap 15c are bonded together at least at the downstream-side end part, the outer flap 15b is prevented from being displaced. Therefore, the regulating member 75 may be configured to be separated from the outer flap 15b immediately after the outer flap 15b and the middle flap 15c are bonded together at the downstream-side end part.

As shown in FIG. 6, in the present embodiment, the outer flap 15b folded downwardly is formed so that the length (width) thereof in the transportation direction decreases downwardly, and the length of the lower end part of the outer flap 15b in the transportation direction becomes shorter than the length of the body portion 15a. When the outer flap 15b having such a shape is in an orientation in which the outer flap 15b is not displaced with respect to the body portion 15a, the upstream-side end part of the outer flap 15b is located on the downstream side of the upstream-side end part of the body portion 15a. Therefore, if the regulating member 75 moving downstream along the transportation direction is configured to come into contact with the upstream-side end part of the body portion 15a, when the orientation of the outer flap 15b is to be regulated, the regulating member 75 comes into contact with the body portion 15a before coming into contact with the outer flap 15b, and thus, the orientation of the outer flap 15b cannot be regulated.

However, in the present embodiment, since the regulating member 75 is configured to come into contact with only the upstream-side end part of the outer flap 15b in the carton 15, even if the upstream-side end part of the outer flap 15b is positioned on the downstream side of the upstream-side end part of the body portion 15a, it is possible to regulate the orientation of the outer flap 15b by bringing the regulating member 75 into contact with the outer flap 15b. Even when the position of the upstream-side end part of the outer flap 15b in the transportation direction varies depending on the specification of the carton 15, it is possible to regulate the orientation of the outer flap 15b by adjusting the timing at which the regulating member 75 comes into contact with the outer flap 15b in accordance with the shape of the outer flap 15b.

In this manner, the orientation of the outer flap 15b in the transportation direction can be regulated in accordance with the shape of the outer flap 15b by bringing the regulating member into contact with only the upstream-side end part of the outer flap 15b.

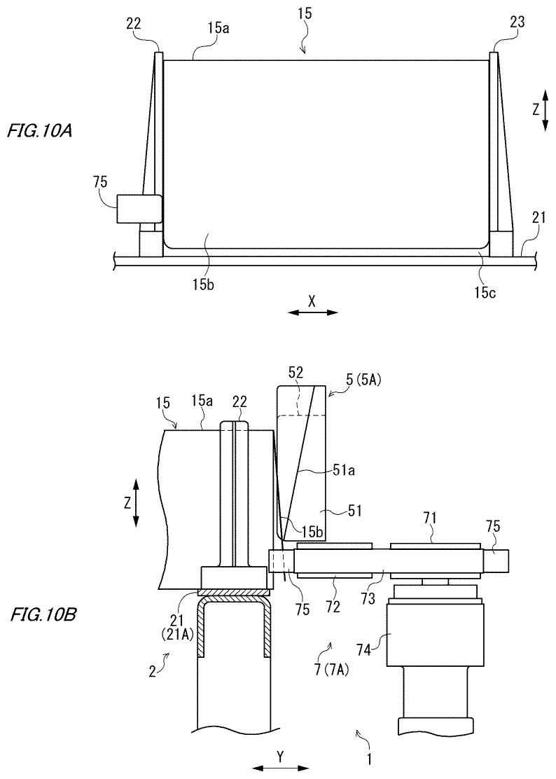

However, as illustrated in FIG. 10, when the length of the lower end part of the outer flap in the transportation direction is the same as the length of the body portion 15a, and the position of the upstream-side end part of the outer flap 15b in an orientation in which no positional displacement occurs coincides with the position of the upstream-side end part of the body portion 15a, the regulating member 75 may be configured to come into contact with both of the upstream-side end part of the outer flap 15b and the upstream-side end part of the body portion 15a. In this case, by bringing the regulating member 75 into contact with both of the upstream-side end part of the outer flap 15b and the upstream-side end part of the body portion to align the position of the upstream-side end part of the outer flap 15b and the position of the upstream-side end part of the body portion 15a, it is possible to regulate the outer flap 15b to an orientation in which no positional displacement occurs.

In a case where the outer flap 15b is formed such that the length (width) thereof in the transportation direction decreases downwardly as illustrated in FIG. 6, and it is sufficient to regulate the displacement to such an extent that the lower end part of the outer flap 15b does not protrude from the body portion 15a, the regulating member 75 may be configured to come into contact with both of the upstream-side end part of the outer flap 15b and the upstream-side end part of the body portion 15a as described above. In this case, by bringing the regulating member 75 into contact with both of the upstream-side end part of the outer flap 15b and the upstream-side end part of the body portion 15a to align the position of the upstream-side end part of the outer flap 15b and the position of the upstream-side end part of the body portion 15a, it is possible to regulate the outer flap 15b to an orientation in which the outer flap 15b does not protrude from the body portion 15a.

Furthermore, in the regulation of the displacement of the outer flap 15b, it is effective and preferable that the regulating member 75 regulates the displacement at the lower end part of the outer flap 15b, that is, at the end part thereof farther away from the body portion 15.

The second transporter 8 is disposed on the downstream side of the pushing roller 6 in the transportation direction of the carton 15. The second transporter 8 includes a transportation conveyor 81A disposed on a lateral part on the filling side of the transportation conveyor 21 in the Y direction, and a transportation conveyor 81B disposed on a lateral part on the filling-side opposite side of the transportation conveyor 21.

The transportation conveyor 81A and the transportation conveyor 81B are configured by belt conveyors extending along the X direction, and each include a belt 811 that is rotationally driven. The belt 811 of the transportation conveyor 81A comes into contact with the outer flap 15b on the filling side in the carton 15, and the belt 811 of the transportation conveyor 81B comes into contact with the outer flap 15b on the filling-side opposite side in the carton 15.

That is, the second transporter 8 transports the carton 15 in which the outer flaps 15b and the middle flaps 15c are bonded together, to the downstream side in a state where the carton is sandwiched in the Y direction by the transportation conveyor 81A and the transportation conveyor 81B. The controller 9 can control the operations of the transportation conveyor 81A and the transportation conveyor 81B, and the transportation, the stop, the transportation speed, and the like of the carton 15 are adjustable by controlling the operations of the transportation conveyor 81A and the transportation conveyor 81B by the controller 9.

In the present embodiment, the carton 15 is placed on the transportation conveyor 21 in an orientation in which the outer flaps 15b are positioned on the upper side and the middle flaps are positioned on the lower side. However, the carton 15 may be placed in an orientation in which the outer flaps 15b are positioned on the lower side and the middle flaps 15c are positioned on the upper side. In this case, the flap-folding guides 5 are configured to fold the outer flaps 15b upwardly.

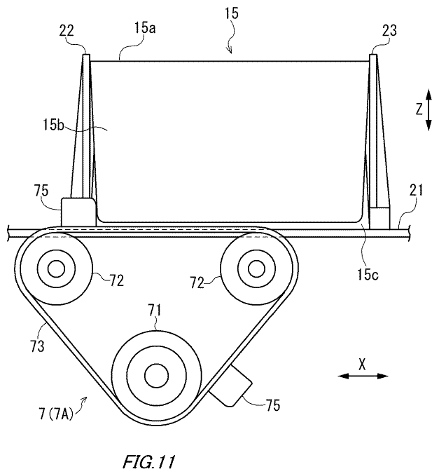

Furthermore, each regulator 7 in the present embodiment is configured such that the rotation shafts of the driving pulley 71 and the driven pulley 72 are disposed in an orientation so as to extend along the vertical direction and the belt 73 rotates on the lateral side of the outer flap However, as illustrated in FIG. 11, the rotation shafts of the driving pulley 71 and the driven pulley 72 may be disposed in an orientation so as to extend along the horizontal direction, and the belt 73 may rotate below the outer flap 15b. Furthermore, in a case of a configuration in which the rotation axes of the driving pulley 71 and the driven pulley 72 are arranged in an orientation along the horizontal direction, the belt 73 may be configured to rotate above the outer flap 15b when the carton 15 is placed such that the outer flap 15b is positioned on the lower side and folded upwardly.

### INDUSTRIAL APPLICABILITY

The present invention is applicable to a box-making device for cartons.

### REFERENCE SIGNS LIST

1 box-making device
2 first transporter
4 coating applicator
5 flap-folding guide
6 pushing roller
7 regulator
15 carton
15a body portion
15b outer flap
15c middle flap
16 bonding material
21 transportation conveyor
22 upstream-side spacer
23 downstream-side spacer
73 belt
75 regulating member
R1 contactable region
R2 retraction region

1. A box-making device for making a carton including a body portion formed in a tubular shape, first flaps formed at axial ends of the body portion, and second flaps facing the first flaps by bonding the first flaps and the second flaps together in a folded state,
the box-making device comprising:
a transporter including a transportation conveyor for transporting the carton and spacers that are provided on the transportation conveyor and are capable of supporting upstream-side end parts of the carton being transported;
applicators for applying a bonding material to the second flaps in a folded state;
flap-folding guides for folding the first flaps at outer sides of the second flaps in a folded state by coming into contact with the first flaps in accordance with the transportation of the carton;
pushing members for pushing the first flaps folded by the flap-folding guides toward the second flaps so as to bring the first flaps and the bonding material applied to the second flaps into contact with each other; and
regulating members for regulating orientations of the first flaps in a transportation direction at least when the contact between the first flaps pushed by the pushing members and the bonding material begins, by coming into contact with at least upstream-side end parts of the first flaps in the carton.

2. The box-making device according to claim 1, wherein the regulating member comes into contact with only the upstream-side end part of the first flap in the carton when regulating the orientation of the first flap.

3. The box-making device according to claim 1, comprising regulators including endless belts to be rotationally driven and the regulating members attached to outer peripheral surfaces of the endless belts, the regulating members moving in accordance with the rotations of the endless belts, wherein
the regulator includes a contactable region where the regulating member moves along the transportation direction of the carton and the moving regulating member is contactable with the first flap, and a retraction region where the regulating member moves at a position farther away from the carton as compared with when the regulating member moves in the contactable region, and
the regulating member that comes into contact with the first flap in the contactable region is separated from the first flap before moving from the contactable region to the retraction region.

4. The box-making device according to claim 3, wherein the regulating member that is separated from the first flap in the retraction region comes into contact with the first flap after moving from the retraction region to the contactable region.
